(19) United States
(12) Patent Application Publication
(10) Pub. No.: US 2007/0228629 A1
(43) Pub. Date: Oct. 4, 2007

(54) Adjustable door spreader

(76) Inventor: Joseph Secreto, Philadelphia, PA (US)

Correspondence Address: MARK J. ROSEN P.C., 418 BARCLAY ROAD, BRYN MAWR, PA, 19010, US

(21) Appl. No.: 11/393,346

(22) Filed: Mar. 30, 2006

(51) Int. Cl. B25B 1/20

(52) U.S. Cl. 269/43

(57) ABSTRACT

The invention relates to an adjustable door spreader apparatus for use in the door framing industry. The apparatus equips a carpenter engaged in framing doors with an adjustable door spreader capable of spreading virtually all common door sizes, thereby saving time and materials by eliminating the need to build a single-use spreader for each door to be framed.

### FIELD OF THE INVENTION

The invention relates to a novel apparatus for use in the door framing industry. Particularly, the apparatus of the invention is an adjustable device which equips a carpenter engaged in framing doors with an adjustable door spreader capable of spreading virtually all doors, thereby saving time and materials by eliminating the need to build a single-use spreader for each door to be framed.

### BACKGROUND OF THE INVENTION

Carpenters use a wide variety of tools to help them with repetitive tasks. Where the construction of a plurality of doors is concerned, one of the critical tasks is spreading the door bucks to the proper spacing prior to securing the doors' sides and the bottom of the bucks to the floor and other securing members of the frame. Ordinarily, a door spreader is fashioned for each door on each new job from wood or other like material, taking time and using materials.

In the past, several tools designed to mitigate the need for crafting new spreaders on each job have been disclosed, however, they generally are complicated, clumsy, expensive, or insufficiently adjustable to accommodate the requirements of most door-framing jobs. For example, U.S. Pat. No. 5,340,095 discloses a door spreader with myriad moving parts, connections, and clamps, but it has disadvantages in that it requires tools such as wrenches to adjust the spread width. Likewise, U.S. Pat. No. 3,851,868 discloses a spreader employing bolts, magnets, and sliding members which allows for adjustability, but is limited in its ability to accommodate doors of different sizes, because the largest spread it can accommodate is somewhat less than twice the smallest spread owing to the nature of the sliding members. Further, at wider spreads, the device is insufficiently stable because its sliding members are extended to their fullest and are secured by only a single bolt.

U.S. Pat. No. 5,775,036 discloses a spreader employing grooves and slots to enable spreading of doors in a range likewise limited by the spread of its sliding members to less than twice the smallest range. Additionally, the lateral ends of the spreader are a single size, such that adaptation to a variety of door buck width sizes is not possible without building additional units.

The art is therefore in need of a superior door spreading apparatus which is useful on a variety of door spread widths and buck sizes, which may be carried by the carpenter to each job and used on the variety of doors in a repetitive fashion such that each door requires only a simple adjustment of the spreader apparatus.

### SUMMARY OF THE INVENTION

The door spreader of the invention satisfies the needs in the art for a spreader which is reuseable on a variety of door framing jobs, which may be carried by individual carpenters to such jobs, and is both inexpensive and particularly well-adapted to its function.

In one aspect, the invention comprises an adjustable door spreader having (a) a base member comprising a top surface having two longitudinally opposed notches and two longitudinal rails extending upward from opposing edges of the top surface; and (b) a slideable member slideably affixed to the base member and retained thereon by the rails, wherein at least one end of the slideable member has a notch; wherein the door spreader may be adjusted to accommodate a variety of widths separating a first door buck and a second door buck.

For door bucks whose width of separation is the same as the width of the base member, the slideable member is unextended; the base member's notches engage the first and second door bucks. However, where the desired door bucks' separation width is greater than that of the base member, the slideable member is extended, wherein one notch of the base member engages the first door buck and the notch of the slideable member engages the second door buck.

The upper surface of the base member optionally has a spline extending longitudinally along the top surface thereof, while the slideable member has a groove extending longitudinally along a lower surface thereof, such that the groove slides along the spline when the slideable member is extended or retracted.

In another aspect, the door spreader further comprises means for securing the slideable member to the base member at a desired extension length. The means for securing comprises pairs of recesses at desired locations of the base member, at least one pair of holes at a desired location of the slideable member, and locking pins capable of passing through the holes in the slideable member into the recesses of the base member. The locking pins are generally any means capable of passing through the slideable member and into the recesses on the base member, and may be, for example, dowels, pins, bolts, wingnuts, screws, and spring-bolts. Preferably, the locking pins are spring-bolts.

The adjustable door spreader optionally has measurement indicators, such as engraved or printed dimensions, along the top surface of the slideable member, the upper edges of the rails, the sides of the base member, or any combination thereof. The measurement indicators are optional because the recesses are spread at precise increments. In use, the door spreader is adjusted to these incremental spread widths.

In another aspect, then, the door spreader may be locked to at least 2 spread widths found in common door frames, and are generally from 24 to 48 inches in 2 inch increments. Any desired increment may be accomplished by spacing the recesses on the slideable member at the desired distance. Preferably, the door spreader may be locked to a variety of common door frame widths, typically in 2 inch increments. Where the base member is 30 inches in its longest dimension, the spread widths are generally variable from 24 inches (using the slideable member only where the slideable member is 24 inches in its longest dimension), 30 inches (using a 30 inch base member with or without the slideable member affixed to the base member, but unextended therefrom), and from 30 to 48 inches in increments of 2 inches. Again, other increments are easily adapted by designing alternative space increments between the recesses on the slideable member.

In another aspect, the adjustable door spreader has an additional adjustable extension member adjustably affixed to the upper surface of the slideable member, thereby providing an additional extension and allowing the door spreader to function with larger door buck spread widths. The adjustable extension member is affixed to the slideable member with securing means, such as dowels, pins, bolts, wingnuts, screws, and spring-bolts, which pass through holes in the extension member into recesses in the upper surface of the slideable member. Extension of the adjustable extension member is accomplished through releasing the securing means, repositioning the extension member, and securing the adjustable extension member to the slideable member through a second pair of holes in the extension member and into the recesses of the slideable member. For example, a 9 inch extension member allows for additional extension up to 4 inches.

In one aspect, an adjustable door spreader with a 30 inch base member, a 24 inch slideable member, and a 9 inch extension member may thus be extended to accommodate spread widths of from 24 to 52 inches in increments of 2 inches, or any combination of at least two of such widths.

In another aspect, an adjustable door spreader with a 24 inch base member, a 20 inch slideable member, and a 7 inch extension member may thus be extended to accommodate spread widths of from 20 to 44 inches in increments of 2 inches, or any combination of at least two of such widths.

A suitable handle may optionally be positioned and affixed to the upper surface of the slideable member. The handle may be used to carry the door spreader as well to assist in extending the slideable member.

In another aspect, the notches of the base member and slideable member are adjustable in width, permitting the door spreader to be employed with a variety of door buck widths, as described more fully below.

The adjustable door spreader may be fabricated from any suitable material known in the art with sufficient rigidity and the ability to be formed into the required dimensions. For example, the base member, slideable member, extension member, and handle are independently made from wood, fiberglass, plastic, PVC, carbon fiber, aluminum, and the like.

The invention also includes methods for spreading a door frame using any of the embodiments of the adjustable door spreader of the invention.

These and other features of the invention are exemplified and further described in the Detailed Description of the Invention below.

### BRIEF DESCRIPTION OF THE DRAWINGS

FIG. 1 is a schematic diagram showing an embodiment of the adjustable door spreader of the invention.

FIG. 2 is a schematic diagram showing an overhead view of an embodiment of the adjustable door spreader of the invention.

FIG. 3 is a schematic diagram showing a side view of an embodiment of the slideable member of the invention, with an extension member affixed thereto.

FIG. 4 is a schematic diagram showing an edge-on view of an embodiment of the adjustable door spreader of the invention.

FIG. 5 is a schematic diagram showing the base member, the slideable member, and the extension member of an embodiment of the adjustable door spreader of the invention.

### DETAILED DESCRIPTION OF THE INVENTION

The door spreader of the invention comprises a base member having a smooth bottom surface, and lateral ends with notches adapted to fit standard door buck widths. The notches may be of a fixed width, or may be adjustable as described below to fit a variety of door buck widths.

The base member may be used by itself for the smallest door frame sizes, as it is designed to precisely fit the smallest standard door sizes, such as 24 inches or 30 inches. To accommodate larger door spread widths, the base further comprises a longitudinal spline running down the middle of the upper surface, and longitudinal rails running down the sides of the base. These features allow a slideable member having a lower and an upper surface, the lower surface having a groove sized to fit along the spline of the base member, and the slideable member being of width such that it fits within the two rails of the base member. The slideable member has its own set of notches on its longitudinal ends to accommodate the door bucks' width. The carpenter using the spreader simply slides the slideable member along the base member until the desired spread width is achieved.

The upper surface of the slideable member optionally has an adjustable third member adjustably affixed thereto to allow further extension and additional spreader width.

Measurement indicators are optionally present on one or more of the upper surface of base member, one or both of the side surfaces of the base member, the upper surface of the slideable member, and the upper surface of the adjustable third member. In one embodiment, the indicators provide markings spaced in intervals of, for example, 2 inches.

Once the desired spread width is achieved, the width of the spreader is secured by securing means which pass through holes through the entire thickness of the sliding member into recesses in the upper surface of the base member adapted to receive the securing means. Generally, a pair of securing means are used, positioned advantageously in opposition on the slideable member. The securing means may be dowels, pins, bolts, or preferably spring bolts which may be released and secured with a simple twist-and-pull action. The recesses in the upper surface of the base member are positioned such that each will engage a securing means, which have been passed through the holes. In the case of spring bolts, a simple twist-and-pull action recedes the spring bolt from being engaged, allowing the sliding member to slide against the base member, whereupon the desired width is achieved. The spring bolts are then twisted back to reengage the recesses at the desired position, achieving a secure engagement of the sliding and base members at the desired width.

Thus, in one embodiment of the invention, an adjustable door spreader has (a) a base member comprising a top surface having two longitudinally opposed notches and two longitudinal rails extending upward from opposing edges of the top surface; and (b) a slideable member slideably affixed to the base member and retained thereon by the rails, wherein at least one end of the slideable member has a notch; wherein the door spreader may be adjusted to accommodate a variety of widths separating a first door buck and a second door buck.

For door bucks whose width of separation is the same as the width of the base member, the slideable member is unextended; the base member's notches engage the first and second door bucks. For example, a base member having a longest dimension of 30 inches accommodates a standard 30 inch door frame, while the slideable member of 24 inches in longest dimension may be used by itself for smaller frames, such as those in smaller closets. However, where the door bucks' separation width is greater than that of the base member, the slideable member is slid within the base member, and extended, wherein one notch of the base member engages the first door buck and the notch of the slideable member engages the second door buck. This allows for spread widths of, for example, 24 inches to 48 inches in desired increments of, for example, 2 inches. In another embodiment, where the base member is 24 inches in width, the door spreader accommodates spreads of 20 to 44 inches.

The upper surface of the base member optionally has a spline extending longitudinally along the top surface thereof, while the slideable member has a groove extending longitudinally along a lower surface thereof, such that the groove slides along the spline when the slideable member is extended or retracted.

In one embodiment, the door spreader further comprises means for securing the slideable member to the base member at a desired extension length. The means for securing comprises pairs of recesses at desired locations of the base member, at least one pair of holes at a desired location of the slideable member, and locking pins capable of passing through the holes in the slideable member into the recesses of the base member. The locking pins are generally any means capable of passing through the slideable member and into the recesses on the base member, and may be, for example, dowels, pins, bolts, wingnuts, screws, and spring-bolts. Preferably, the locking pins are spring-bolts, such as those available from McMaster-Carr (e.g., “Pull-Ring” Hand-Retractable Spring Plungers, found in the online catalog at mcmaster.com), and may be made of brass, steel, or the like.

The adjustable door spreader optionally has measurement indicators, such as engraved or printed dimensions, along the top surface of the slideable member, the upper edges of the rails, the sides of the base member, or any combination thereof.

In an embodiment of the invention, the door spreader may be locked to at least 2 spread widths found in common door frames, and are generally 24 to 52 inches, in desired increments. Preferably, the door spreader may be locked to all these common door frame widths. Further, the recesses in the base member may be more numerous to allow for locking of the slideable member at additional, less common, widths.

In another embodiment, the adjustable door spreader has an adjustable extension member adjustably affixed to the upper surface of the slideable member, thereby providing an additional extension and allowing the door spreader to function with larger door buck spread widths. The adjustable extension member is affixed to the slideable member with securing means, such as dowels, pins, bolts, wingnuts, screws, and spring-bolts, which pass through holes in the extension member into recesses in the upper surface of the slideable member. Extension of the adjustable extension member is accomplished through releasing the securing means, repositioning the extension member, and securing the adjustable extension member to the slideable member through a second pair of holes in the extension member and into the recesses of the slideable member. For example, an extension member of 9 inches provides for additional extension of 4 inches.

In another embodiment, then, the adjustable door spreader with a 30 inch base member may thus be extended to accommodate spread widths of 24 to 52 inches, or any desireable combination of at least two of such widths. Preferably, the door spreader is capable of accommodating all such widths, and may be optionally machined to allow for less common widths in between these standard widths. For example, where a 2 increment is desired, the door spreader accommodates spread widths of 24, 26, 28, 30, 32, 34, 36, 38, 40, 42, 44, 46, 48, 50, and 52 inches. In another embodiment, where the base member is 24 inches long, the door spreader accommodates door buck spread widths of 20 to 44 inches when the slideable member and extension members are utilized. Preferably a 2 inch increment is used, thus allowing for spread widths of 20, 22, 24, 26, 28, 30, 32, 34, 36, 38, 40, 42, and 44 inches.

A suitable handle may optionally be positioned and affixed to the upper surface of the slideable member. The handle may be used to carry the door spreader as well to assist in extending the slideable member.

In another aspect, the notches of the base member and slideable member are adjustable in width, permitting the door spreader to be employed with a variety of door buck widths. For example, in one embodiment, the notches, as defined by their protruding sides are 2½ inches wide, but may be adjusted to greater or lesser width by adapting one of the protruding sides defining the notches to be movably adjustable, thereby allowing for door buck widths of from about 1 inch to about 3 inches.

The adjustable door spreader may be fabricated from any suitable material known in the art with sufficient rigidity and the ability to be formed into the required dimensions. For example, the base member, slideable member, extension member, and handle are independently made from wood, fiberglass, plastic, PVC, carbon fiber, aluminum, and the like. Each of the base member, the slideable member, and the extension member may be constructed from a single piece of material, or may be constructed from separate pieces which, when appropriately joined, formed the respective member. Preferably the door spreader is made of wood or fiberglass.

The dimensions of the door spreader are chosen for the particular spread of widths intended to be accommodated. Preferably, the door spreader is capable of spreading from 24 inches to 52 inches including a plurality of 2 inch increments thereof, more preferably including a majority of 2 inch increments thereof, more preferably including substantially all 2 inch increments thereof, and most preferably including all 2 inch increments thereof.

The invention also includes methods for spreading a door frame using any of the embodiments of the adjustable door spreader of the invention. In these methods, the carpenter lays the door spreader between the door bucks and adjusts the door spreader to the desired width, either by using the notches in the base member alone, or by extending the slideable member to a greater width, engaging one of the slideable member's notches with the first door buck and the base member's notch with the other, or by extending the extension member to achieve greater widths than possible with the slideable member alone.

### EXAMPLES

The present invention will be further understood by reference to the following non-limiting examples.

### Example 1

### Adjustable Door Spreader with 30 Inch Base Member

With specific reference to the Figures, this Example illustrates an embodiment of the invention wherein the base member is 30 inches in its longest dimension. Made from wood, the door spreader is 30 inches wide, 7 inches across, and 2 inches high (including the height of the rails). The base member (1) as depicted in FIG. 1 is constructed from ¾ inch thick wood. The rails (2) are a total of 2 inches high and ½ inch thick, and, as shown in FIG. 4, at the top ¼ inch of the rails, extend medially 3/4 inches from the edge of the base member toward the center of the base member to retain the slideable member (4) in a flange-like manner, thereby providing a 1/4 inch overhanging retaining portion of the rail.

The notches on the base member (3) are defined by tongs extending outward from the base member by ¾ inches, though they may alternatively extend outward by ½ inch to about 1 inch. The tongs are each 1¾ inches across. The notches defined by the tongs extended from the base member are therefore 2½ inches across, accommodating door bucks of up to 2½ inches in width.

The top surface of the base member has a 2 inch across spline (6), either side of which are recesses (7), beginning from between about 4 and 6 inches from either end of the base member, preferably between 5 and 5½ inches, and spaced in an interval of every 2 inches. The recesses (7) are set about 1 inch from the rails in order to match with the pair of holes (9) in the slideable member.

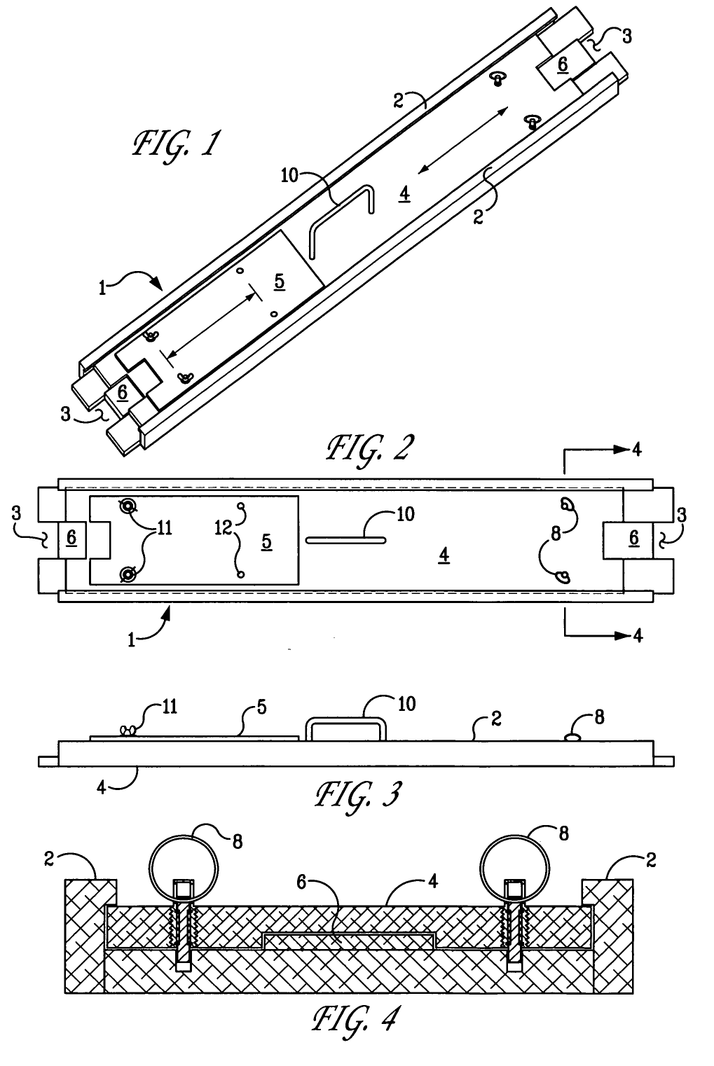

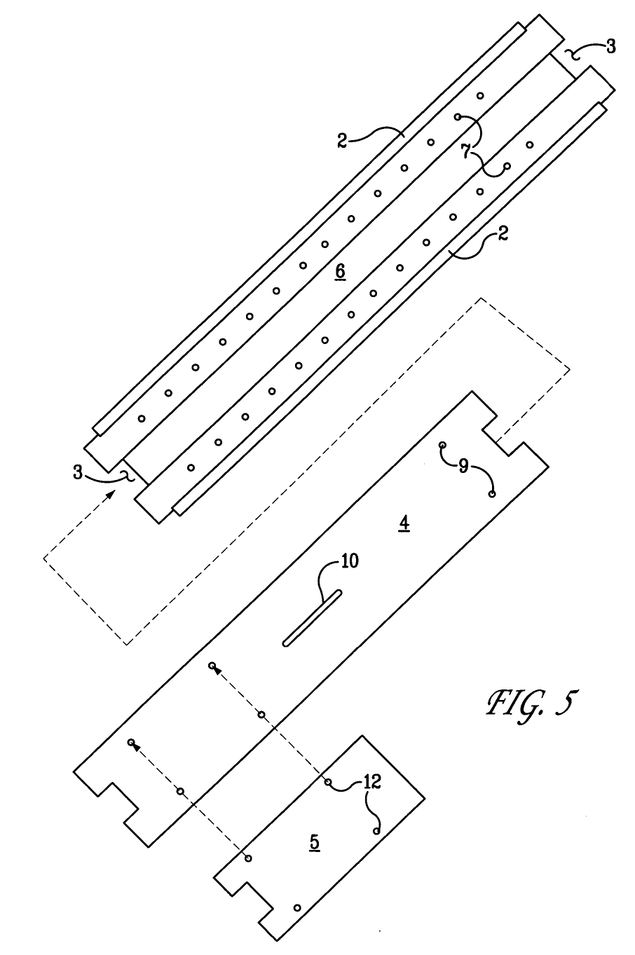

The slideable member (4) depicted in FIG. 3 is 24 inches in width, 5⅞ inches across, and 11/16 inches thick. The slideable member (4) has notches (3) such that the space defined by the tongs thereof are of similar width to those of the base member (1). The thickness of the notches (3) shown in FIG. 3 may be less than the full thickness of the slideable member (4), or the notches (3) may be fully as thick as the slideable member (4) itself. In this example, a groove matching the dimensions of the spline (6) (which in this example is ⅛ inch thick) is provided on the lower surface of the slideable member (4). As depicted in FIG. 5, the slideable member (4) has two pairs of recesses towards one end for adjustably affixing the extension member (5), only one pair of recesses being utilized at a particular time depending on the desired door buck spread width. The slideable member may have three pairs of recesses, 2 inches apart, to allow for adjusting the extension member to extend by 0, 2, or 4 inches. Towards the opposite end of the slideable member, at a position about 2½ inches from the end of the slideable member, is a pair of holes (9) through which the locking pins (8) (shown in FIGS. 2, 3, and 4) are passed, for securing the slideable member (4) to the base member (1). The pair of holes (9) are each set back from the edge of the slideable member by 15/16 inches. The locking pins (8), after passing through the holes (9), pass into the recesses (7) of the base member. A handle (10) is also provided on the slideable member (4).

The extension member (5) as depicted in FIG. 5 is 9 inches in width, 5½ inches across, and ½ inch thick. It has a notch at only one end, the tongs of which define a space having dimensions as in the notches of the base member and slideable member, although the space defined by the tongs may be less, such as 2¼ inches. Two pairs of holes (12) are positioned on the extension member (5) such that it may be affixed to the slideable member (4) at either an unextended position (see FIG. 2), or in an extended position. The affixing is accomplished by means of wingnuts (11) which pass through the holes (12) and into the recesses in the slideable member (4). As shown in the Figures, the extension member (5) has two pairs of holes for extension purposes, however, if desirable, the extension member (5) may have additional pairs of holes for additional extension width possibilities. For example, three pairs of holes may be used to accommodate extension by 0, 2, and 4 inches.

FIG. 1 depicts the fully assembled adjustable door spreader, showing the base member (1), the slideable member (4) in unextended position, and the extension member (5) in unextended position. FIG. 5 depicts the unassembled door spreader, indicating the manner in which it is assembled for use.

The door spreader is used by placing it between door bucks and adjusting the door spreader so that the notches present in the appropriate member define the desired spread width. For example, a 30 inch spread width is accomplished by merely keeping the slideable member and extension member in unextended positions. A 36 inch spread width is accomplished by releasing the spring-bolts, sliding the slideable member 6 inches, and resecuring the spring-bolts. One notch of the base member abuts one of the door bucks, while one notch of the slideable member abuts (or defines the position) for the other door buck. The door bucks are then affixed to form a door frame of precise desired width. Similarly, a 52 inch spread width may be accomplished by extending the slideable member by 18 inches, and then the extension member to its fully extended position (yielding an additional 4 inches of extension), bringing the total width of the adjusted spreader to 52 inches.

### Example 2

### Adjustable Door Spreader with 24 Inch Base Member

This example differs from Example 1 in that the base member (1) is 24 inches wide, the slideable member is 20 inches wide, and the extension member is 7 inches wide. This example apparatus is capable of spreading from 24 inches to 44 inches.

It will be apparent to persons skilled in the art that numerous enhancements and modifications can be made to the above described apparatus without departing from the basic inventive concepts. All such modifications and enhancements are considered to be within the scope of the present invention, the nature of which is to be determined from the foregoing description and the appended claims. Furthermore, the preceding Examples are provided for illustrative purposes only, and are not intended to limit the scope of the invention. All references cited herein are expressly incorporated by reference herein.

I claim:

1. An adjustable door spreader, comprising:
a) a base member comprising a top surface and having two longitudinally opposed notches, and comprising two longitudinal rails extending upward from opposing edges of the top surface; and
b) a slideable member slideably affixed to the base member and retained thereon by the rails, wherein the slideable member has longitudinally opposed notches;
whereby the door spreader may be adjusted to accommodate a variety of widths separating a first door buck and a second door buck.

2. The adjustable door spreader of claim 1, wherein the upper surface of the base member has a spline extending longitudinally along the top surface thereof, and the slideable member has a groove extending longitudinally along a lower surface thereof, wherein the groove slides along the spline when the slideable member is extended or retracted.

3. The adjustable door spreader of claim 2, further comprising means for securing the slideable member to the base member at a desired extension length.

4. The adjustable door spreader of claim 3, wherein the means for securing comprises pairs of recesses at desired locations of the base member, at least one pair of holes at desired locations of the slideable member, and locking pins capable of passing through the holes in the slideable member into the recesses of the base member.

5. The adjustable door spreader of claim 4, wherein the locking pins are selected from the group consisting of dowels, pins, bolts, wingnuts, screws, and spring-bolts.

6. The adjustable door spreader of claim 5, wherein the locking pins are spring-bolts.

7. The adjustable door spreader of claim 4, wherein the base member and the slideable member further comprise measurement indicators.

8. The adjustable door spreader of claim 4, further comprising an adjustable extension member adjustably affixed to the upper surface of the slideable member.

9. The adjustable door spreader of claim 8, wherein the adjustable extension member is affixed to the slideable member with wingnuts which pass through any of a plurality of a pair of holes in the extension member into recesses in the upper surface of the slideable member.

10. The adjustable door spreader of claim 8 which may be locked to at least six widths selected from the group consisting of 20, 22, 24, 26, 28, 30, 32, 34, 36, 38, 40, 42, and 44 inches.

11. The adjustable door spreader of claim 8 which may be locked to at least ten widths selected from the group consisting of 20, 22, 24, 26, 28, 30, 32, 34, 36, 38, 40, 42, and 44 inches.

12. The adjustable door spreader of claim 8 which may be locked to at least six widths selected from the group consisting of 24, 26, 28, 30, 32, 34, 36, 38, 40, 42, 44, 46, 48, and 52 inches.

13. The adjustable door spreader of claim 12 which may be locked to at least ten widths selected from the group consisting of 24, 26, 28, 30, 32, 34, 36, 38, 40, 42, 44, 46, 48, and 52 inches.

14. The adjustable door spreader of claim 13, wherein at least one notch width of the base member or slideable member are adjustable in width.

15. A method for spreading a door frame comprising the step of spreading the door bucks using the adjustable door spreader of claim 1.

16. A method for spreading a door frame comprising the step of spreading the door bucks using the adjustable door spreader of claim 4.

17. A method for spreading a door frame comprising the step of spreading the door bucks using the adjustable door spreader of claim 10.

18. A method for spreading a door frame comprising the step of spreading the door bucks using the adjustable door spreader of claim 11.

19. A method for spreading a door frame comprising the step of spreading the door bucks using the adjustable door spreader of claim 12.

20. A method for spreading a door frame comprising the step of spreading the door bucks using the adjustable door spreader of claim 13.
